(19) United States
(12) Patent Application Publication
(10) Pub. No.: US 2018/0322705 A1
(43) Pub. Date: Nov. 8, 2018

(54) AUGMENTED OR VIRTUAL REALITY INTERACTIVE EDIBLE STICKER

(71) Applicant: Bob D. Ntoya, North Hills, CA (US)

(72) Inventor: Bob D. Ntoya, North Hills, CA (US)

(21) Appl. No.: 15/970,871

(22) Filed: May 3, 2018

Related U.S. Application Data
(60) Provisional application No. 62/501,017, filed on May 3, 2017.

(51) Int. Cl. G06T 19/00; G06T 7/70; G06K 9/00

(52) U.S. Cl. CPC G06T 19/006; G06K 9/00671; G06T 7/70

(57) ABSTRACT

Embodiments of the present invention include an ingestible sticker including an edible paper and an edible ink on a surface of the edible paper creating a sticker image, wherein the sticker image is configured to be recognized by an augmented or virtual reality capable device.

### CROSS-REFERENCE TO RELATED APPLICATION(S)

This application claims the benefit of U.S. Provisional Patent Application Ser. No. 62/501,017, filed May 3, 2017, the content of which is hereby incorporated by reference in its entirety.

### REFERENCE TO COMPUTER PROGRAM LISTING APPENDIX

A computer program listing is submitted electronically herewith pursuant to MPEP 508.05(I) and is hereby incorporated by reference. The electronically submitted listing includes ASCII files entitled “AnimationManager.txt,” “MicrosoftVisualStudio.txt,” “C-Sharp.txt,” and “Build.txt.”

### BACKGROUND OF THE INVENTION

According to the data from U.S. Centers for Disease Control and Prevention, almost one-third of kids are overweight or obese in the U.S. The number of obese children has tripled in the last three decades. In addition, children who are obese have a much higher risk of being obese as adults. Obesity leads to increased risks of health complications later in life, such as possible increased risks of heart disease, stroke, diabetes, hypertension and various types of cancers.

Encouraging children to eat healthy foods, such as fruits and vegetables, can help create healthy eating habits for life, helping to fight against childhood and adult obesity. One such way to encourage healthy eating is by using Edible Stickers® on healthy foods. Edible Stickers® incorporate images of silly faces or favorite cartoon characters, like Dora the Explorer or Spongebob, among a variety of other fun images, making eating healthy foods fun and entertaining for kids. Thus, using Edible Stickers® on healthy foods can help promote healthy eating habits. Attached as Appendix A is a U.S. patent application having the Ser. No. 14/054,818 to Applicant discussing embodiments of the Edible Stickers® including nutrients, which further benefit the health of a child or adult eating the Edible Sticker®. Appendix A is hereby incorporated by reference.

Additional improvements are desired to make Edible Stickers® and similar products more interactive in order to further engage the user and promote healthy eating. In particular, improved products and methods utilizing Augmented or Virtual Reality technologies are desired to allow the user to interact with the images and characters on the Edible Stickers® or similar devices.

The above information disclosed in this Background section is only for enhancement of understanding of the background of the disclosure and therefore it may contain information that does not constitute prior art.

### SUMMARY OF THE INVENTION

Embodiments of the present invention include an ingestible sticker including an edible paper and an edible ink on a surface of the edible paper creating a sticker image, wherein the sticker image is configured to be recognized by an augmented or virtual reality capable device.

Further embodiments include a system for creating an augmented or virtual reality experience using an ingestible sticker, where the ingestible sticker includes an edible paper and an edible ink on a surface of the edible paper creating a sticker image, wherein the sticker image is configured to be recognized by an augmented or virtual reality capable device; and the system includes an application stored in a memory of the augmented or virtual reality capable device and configured to create an augmented or virtual reality when the ingestible sticker is located and the application is running.

Further embodiments include a method for using an ingestible sticker with an augmented or virtual reality application, where the ingestible sticker includes an edible paper and an edible ink on a surface of the edible paper creating a sticker image, wherein the sticker image is configured to be recognized by an augmented or virtual reality capable device and wherein the application is configured to be stored in a memory of the augmented or virtual reality capable device, the augmented or virtual reality capable device having a camera and a screen. The method includes affixing the ingestible sticker to a designated substrate; loading the application on the augmented or virtual reality capable device; directing the camera of the augmented or virtual reality capable device at the ingestible sticker; retrieving sensory information from the camera by the application; recognizing the sticker image; and initiating an augmented or virtual reality experience based on the recognized sticker image.

### BRIEF DESCRIPTION OF THE DRAWINGS

Further features and aspects will become apparent and will be best understood by reference to the following detailed description reviewed in conjunction with the drawings. In the drawings:

FIG. 1 is a plan view of an ingestible sticker according to an embodiment of the present invention.

FIG. 2 is a cross-sectional view of the ingestible sticker of FIG. 1 along line I-I.

FIG. 3 is an example of an AR or VR capable device being used with the ingestible sticker according to an embodiment of the present invention.

FIG. 4 is an example of a fiducial marker that may be associated with the ingestible sticker illustrated in FIG. 1 according to an embodiment of the present invention.

FIG. 5 is a flow chart of the ingestible sticker being used with a AR or VR capable device according to an embodiment of the present invention.

### DETAILED DESCRIPTION

Hereinafter, example embodiments will be described in more detail with reference to the accompanying drawings. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the illustrated embodiment in use or in operation, in addition to the orientation depicted in the figures. For example, if the embodiment in the figures is turned over, elements described as “below” or “beneath” or “under” other elements or features would then be oriented “above” the other elements or features. Thus, the example terms “below” and “under” can encompass both an orientation of above and below. The embodiment may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Embodiments of the present invention include edible, ingestible stickers, such as Edible Stickers©, that are associated with an Augmented Reality (AR) or Virtual Reality (VR) experience. For example, in some embodiments, the sticker is readable by a mobile application or website that uses the readable sticker to create an interactive image of the sticker on a computer monitor or mobile device screen, e.g., making the sticker appear to come to life. The sticker may, for example, provide educational or fun information regarding the food item on which the sticker is placed. Alternatively, the sticker can be visualized through a headset as part of a VR experience. The VR experience may be a mixed reality experience including both virtual and real images, such a virtual animated sticker characters in a real world background.

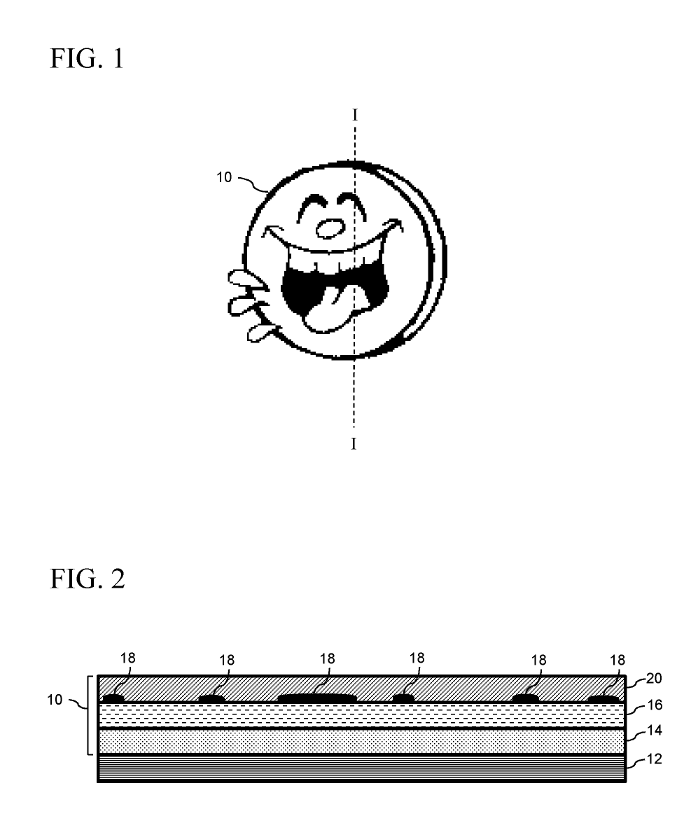

FIG. 1 is a plan view of an ingestible sticker 10 according to an embodiment of the present invention. FIG. 2 is a cross-sectional view of the ingestible sticker 10 along line I-I.

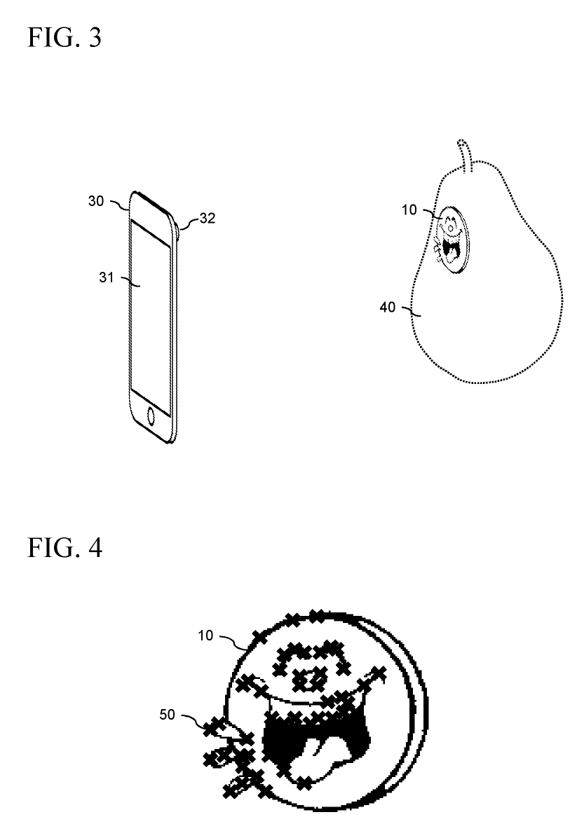

The ingestible sticker 10 can include multiple layers, including an edible adhesive 14, an edible paper 16 and an edible ink 18. The ingestible sticker 10 may be attached to a backing 12 to protect the adhesive 14 until the sticker 10 is transferred to a designated substrate, which can include a variety of foods, like fruits (such as the pear 40 of FIG. 3), vegetables, cookies or cakes. The backing 12 also facilitates printing the edible ink 18 onto the edible paper 16 by allowing the ingestible sticker 10 on the backing 12 to be run through a printer.

The adhesive 14 is a food grade adhesive that can be naturally or synthetically-derived. In some embodiments, the adhesive 14 can include sugar-based adhesives made from plant oils, fatty acids, plant proteins, rosin, natural latex and/or rubber. The adhesive 14 may also be a starched base to utilize starch's inherent tackiness along with a food-based cross-linking polyfunctional acid and sugar to bond the edible paper 16 to the designated substrate. The adhesive 14 may conform to various regulations and codes for the safe use of products in food and packaging for any countries in which the ingestible stickers are sold.

The adhesive 14 is adhered to a bottom surface of the edible paper 16, as shown in FIG. 2. The edible paper 16 is a food grade material that is, for example, naturally derived from edible plants. For example, the paper 16 can be made from sugars and/or starches, such as tapioca or potato starch. The paper 16 may also be derived from rice. In embodiments in which the paper 16 is made of starch, such as tapioca starch, an adhesive 14 may not be needed. Starches are naturally adhesive when combined with moisture. Thus, on moist substrates, such as fruit or vegetables, edible paper made from starch will adhere without the necessity of an additional adhesive. For non-moist surfaces, the back of the edible sticker can be moistened prior to application to the substrate, such as via the addition of water or licking the back of the edible paper. Alternatively, an adhesive 14 can be used.

In some embodiments, the paper 16 can include a natural flavoring.

To create the image on the edible paper 16, a top surface of the paper 16 is printed with the edible ink 18. The edible ink 18 is also be made of food grade materials. The edible ink 18 may include thickening agents (such as hypromellose and/or coconut oil), surface tension modifiers (such as water), antioxidants (such as citric acid), emulsifiers (such as hypromellose and/or polyglycerol esters of fatty acids, which may be derived from any of various natural oils or tallow), buffering agents (such as sodium bicarbonate), preservatives and/or antimicrobial agents (such as citric acid or small percentages of alcohol), flavorings (such as natural flavors and/or glycerin, which may be naturally derived from vegetables), and sugar, in addition to synthetic or natural dyes to provide color to the edible ink 18. Examples of synthetic dyes which can be used are FD&C Red #3, FD&C Red #40, FD&C Yellow #5, FD&C Yellow #6, FD&C Blue #1, and/or FD&C Green #3. Examples of natural dyes that can be used are vegetable juices, natural caramel color, chlorophyll extract, spirulina, spinach extract, red beet extract, red cabbage extract, grape skin extract, cochineal extracts, turmeric oleoresins, and gardenia extracts. The edible ink 18 can be a single color or multiple colors to create more complex images.

The edible ink 18 is included in a concentration sufficient to allow the image printed with the edible ink 18 to be recognized by (i.e., capable of being interpreted by) an AR or VR capable device. In particular, the edible ink can be included in a concentration sufficient to allow the image to be recognized by the AR or VR device on the substrate on which the ingestible sticker 10 is placed. For example, in some embodiments, the image printed with the edible ink 18 is recognizable by an AR or VR device when the ingestible sticker 10 is placed on a food item, such as a fruit, vegetable, cookie or cake. In embodiments in which the edible ink 18 includes natural dyes, the concentration of natural dyes can be increased such that the image printed with the edible ink 18 is sufficiently opaque to allow the ingestible sticker 10 to be recognized by the AR or VR capable device.

The edible ink 18 can be loaded into a printer cartridge to facilitate printing the image onto the edible paper 16 using the edible ink 18. Printing the image onto the edible paper can help make crisp images that persist, allowing the image to be recognizable by an AR or VR device. Alternatively, the edible ink can be screen printed onto the edible paper.

In some embodiments, a protective film or layer 20 may be coated on the edible paper 16, i.e., over a surface of the edible paper 16 that is printed with the edible ink 18, as shown in FIG. 2. The protective layer 20 may protect the ink from smearing in order to protect the integrity of the image printed on the paper 16. Components of the protection layer 20 may be made of food grade materials that may include proteins, carbohydrates and lipids. These materials may be utilized as a mixed blend to form the protection layer 20 and may not adversely alter the flavor of the ingestible sticker 10. The lipids, including fats and/or waxes may be of natural origin which have been approved by the Food and Drug Administration.

In other embodiments, a protective layer is not needed. For example, if the ingestible sticker is protected by other means during transport, a protective layer may not be necessary. For example, the ingestible sticker may be included in a protective sleeve or covering during transport. The sleeve may be made of plastic, such as polyethylene terephthalate, or other suitable protective covering. Opaque plastic coverings, such as Mylar and the like, can help protect the ingestible sticker during transport from both physical damage and potential light degradation.

The ingestible sticker 10 may include an image as shown in FIG. 1, it may include words, or it may include a combination of both. In some embodiments, the ingestible sticker may include the Price Look Up Code (PLU). PLU, codes are commonly used on produce to facilitate check out and inventory control. PLUs are currently included on stickers attached to unpackaged produce, such as fruits and vegetables, to allow purchase of an individual piece of produce. The ingestible sticker 10 may be used instead of current non-ingestible PLU stickers by incorporating the PLU onto the ingestible sticker.

FIG. 3 is an example of an AR or VR capable device 30 being used with the ingestible sticker 10. The AR or VR capable device may be any computing device that is AR/VR compatible, such as a personal computer, game-consoles, or any media player, such as Holo-Lens and or Google Glasses, or a mobile device, such as the mobile device 30 depicted in FIG. 3. The mobile device 30 may have a touchscreen 31 for example, a touch-sensitive phone or tablet and the mobile device 30 may be running an operating system, such as Android or iOS, though, the invention is not limited thereto. A non-touchscreen device or a different operating system may be used. The mobile screen can have a camera 32 that can be used to recognize the ingestible sticker 10 on a designated substrate 40, which is representatively shown in the illustrated embodiment as a pear 40.

In some embodiments, an application may be downloaded onto the mobile device 10 that includes software capable of recognizing the ingestible sticker 10 and initiating an AR or VR experience. The software may be written in any suitable coding language capable of being used with the mobile device 30, such as, for example, javascript or html. The software can be executed by a processor of the mobile device 30 to allow the application to access the camera 32 and to allow the mobile device 30 to receive sensory information from the camera 32. When the camera 32 is directed at the ingestible sticker 10, the camera will receive sensory information regarding the ingestible sticker 10 and its surrounding environment. The application may use this sensory information to identify the ingestible sticker 10 and the environment surrounding the ingestible sticker 10.

For example, the application may utilize fiducial markers in order to identify the ingestible sticker 10. The fiducial marker, which may include, for example, clearly defined edges or lines, specific reference points, a quick response (QR) code, is stored by the application on the mobile device or on a local server accessible by the application. Each stored fiducial marker corresponds to a particular ingestible sticker and is designed to provide sufficient information to locate its respective ingestible sticker reliably. The application compares the stored fiducial markers to the sensory information received from the camera 32 to determine if the sensory information corresponds to a particular fiducial marker and thus, to a particular ingestible sticker 10.

FIG. 4 is an example of a fiducial marker 50 that may be associated with the ingestible sticker 10 illustrated in FIG. 1. In FIG. 4, the fiducial marker 50 includes multiple reference points designated by x's. While in this embodiment the fiducial marker 50 covers the entire ingestible sticker 10, the invention is not so limited and the fiducial marker may cover a subset of the ingestible sticker, such as an image, text or combination of an image and text that are included in a larger ingestible sticker. In some embodiments, the fiducial marker may include a QR code, a barcode, or other suitable pattern.

By comparing this fiducial marker 50 to the illustrated ingestible sticker 10, the application can recognize that the image of the ingestible sticker 10 correlates to the stored reference points of fiducial marker 50, and thus the ingestible sticker 10 and its bounds would be recognized by the application.

The fiducial marker can also be used to help define the scale for implementing AR content by providing a reference point to compare to the size of the real world. Using the fiducial marker, the scale for rendering computer generated content can be determined by comparison calculations between the real-world scale of the fiducial marker and its apparent size in the visual feed.

In alternative embodiments, instead of fiducial markers, the ingestible sticker 10 may be recognized using markerless identification. In such embodiments, the application would include algorithms configured to recognize patterns or particular features that may exist in the sensory information provided by the camera 32 to determine if an ingestible sticker in included in the sensory information.

In other embodiments, instead of using an application on the mobile device to recognize the ingestible sticker 10, a website may be loaded on the mobile device 30 that is capable of recognizing an image on the ingestible sticker 10 and then initiating the AR or VR experience by or through an application. In some embodiments, the ingestible sticker may include a data-matrix code, such as a QR code, within an image on the ingestible sticker. The user would point the camera of the mobile device at the image, and the mobile device would turn the codes into a web address, and its browser could call up an appropriate web page with further information to direct the user to a specific application.

Once the ingestible sticker 10 has been identified, the application can include software that allows the application to track the ingestible sticker 10 when it moves within the field of view of the camera 32. By being able to track the ingestible sticker 10, a virtual image can be overlaid onto the ingestible sticker image even if the sticker is moving within the field of view of the camera 32, for example, helping to create the perception to the mobile device user of an augmented reality in which the ingestible sticker 10 is animated within the background of the real world.

Tracking can determine the position and orientation of the ingestible sticker image so that graphics can be rendered accurately. In embodiments using fiducial markers, the fiducial marker can be used to track the location and orientation of the ingestible sticker. For example, the fiducial marker 50 can be used to track the position and orientation of the ingestible sticker 10. If used for tracking, the fiducial marker can include sufficient information to accurately determine the position and orientation of the ingestible sticker.

In markerless embodiments, a pattern can be placed onto the ingestible sticker to be tracked. Like tracking with fiducial markers, the pattern may be unique in the environment and designed to provide a tracking system with sufficient information to locate the pattern reliably in the image and accurately determine the position and orientation of the pattern and, thereby, the position and orientation of the ingestible sticker to which the pattern corresponds. In some embodiment, the pattern may be captured by the camera 32 of the mobile device 30. In others, the pattern may be provided by a dedicated tracking system in the application.

In some embodiments, the pattern may include three markers whose locations within the ingestible sticker are known. The position and orientation of the ingestible sticker are calculated by the application by using positions of the identified markers in the image input, and the positional information of the markers with respect to image of the ingestible sticker.

The application on the mobile device 30 can also include software to utilize the sensory information to create the augmented or virtual reality. The application software can overlay computer-generated information (i.e., a virtual image) in real time on top of the ingestible sticker 10 while leaving the live view of the real-world environment around the ingestible sticker 10. The virtual image may include animation, graphics, sound effects, and/or other audio or visual features. Thus, when the virtual image is displayed on the screen 31 of the mobile device 30, the application software can make it appear like the ingestible sticker 10 is animated or alive in the real world. For example, in some embodiments, the virtual image of the ingestible sticker 10 may move its facial features and talk to the user of the mobile device 30 while the user can still see the food or other substrate on which the ingestible sticker 10 is attached and the rest of the real world in the background. In some embodiments, the virtual image may include a character that may interact with the real world, for example, interacting with the food or substrate to which it is attached. In some embodiments, the ingestible sticker 10 may tell stories, jokes or fun facts to make children excited about eating healthy food, in particular, a healthy food to which the ingestible sticker 10 is attached.

The ingestible sticker may come to life in the backdrop of the real world. The application software can display the sensory information received from the camera 32 with the virtual image superimposed on the sensory information. For embodiments using VR, the user may wear a head-up display like the Samsung GearVR, Oculus Rift, Microsoft HoloLens, etc. and may interact with a character on the ingestible sticker in the virtual world. In some embodiments, this virtual world may be a mixed reality, with the virtual image superimposed on a background of the real world.

The ability to overlay virtual content (AR/VR content) on the physical world and to have the two interact in real time can create an immersive and engaging experience for the user. The application is being run on the processor of the mobile device 30 to recreate a real world background in virtual space with the virtual image on the ingestible sticker 10.

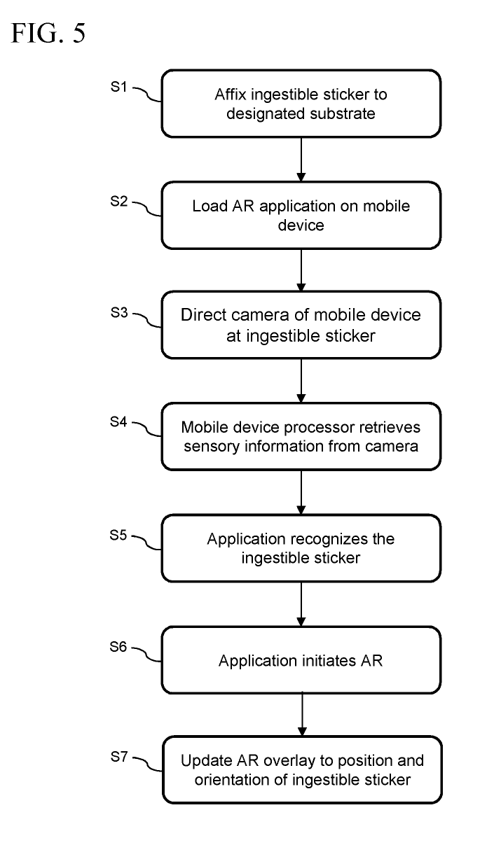

FIG. 5 is a flow chart of the ingestible sticker 10 being used with an AR or VR capable device according to an embodiment of the present invention. According to the illustrated embodiment, the ingestible sticker 10 is removed from its backing 12 and adhered (S1) to a designated substrate, such as a food item. The AR or VR capable application associated with the ingestible sticker is downloaded and loaded (S2) onto the mobile device. These two steps need not occur in this particular order or even by the same person. For example, a company that sells produce my affix the ingestible sticker to its products as part of a marketing plan. A customer who purchases a piece of produce with the ingestible sticker attached may then download and load the application for use with the ingestible sticker on the purchased produce. Or, alternatively, the customer may have already downloaded the application for a prior use.

Once the application is loaded, the user will direct (S3) the camera towards the ingestible sticker. The application software will instruct the processor of the mobile device 30 to retrieve (S4) the sensory information from the camera 32. The application will then use the sensory information to recognize (S5) the ingestible sticker 10 and its bounds using either a fiducial marker or markerless identification. Alternatively, a website may be loaded on the mobile device 30 that is capable of recognizing the ingestible sticker 10.

The application software with the initiate (S6) the AR or VR experience to be overlaid onto the image of the ingestible sticker 10. The ingestible sticker 10, through the virtual image, can appear to become animated, including graphics, video clips, sound effects and/or other audio or visual effects to create an interactive experience with the user. The application software will continue to track to the position and orientation of the ingestible sticker 10 within the field of view of the camera, and update (S7) the AR/VR overlay to continuously position the AR effects over the ingestible sticker 10 in the correct orientation. In some embodiments, animation clips or other audiovisual effects may overlay on the exact shape of the ingestible sticker 10. In some embodiments, the user of the application may watch the animations from any angle once started, may pause the content, or even zoom in and out as if viewing a real-life object. The virtual image may become animated with a voice, music, etc., all in real time.

Animation clips may be provided as movie files or any other file with the audio and video being synchronized via an alpha or transparent channel. Animation clips may come from existing clips created by the animator or the user and may create them in suitable 3^{rd} party software's such as Mixamo Fuse for Windows, Mac, Linux, iClone, Web/Cloud. The user may manually modify the rigging (map of the character skeleton) and animation (by applying movement to skeleton points which will in turn move the actual mesh) and import it to another 3rd party software such as Blender or Unity (.fbx) so they can work seamlessly within a 3rd party software animation system. Animation clips may be in digital format.

Embodiments of the present invention can blur the line between what's real and what's computer-generated by enhancing what user sees, hears, feels, and smells.

Embodiments of the present invention may utilize vaping technology to emit different smells. As such, the user may use a mobile device with a vaping device to emit these different smells. Recreational vaporizers, suitable for vaping loose materials or even watery e-liquids may be used. However, any suitable application with a smell emitting device may be used. For example, a sublimator/vaporizer that allows for the vaporization of unidentified substances via a dual-chamber system can be used. In some embodiments, the use would allow for some kind of thick liquid or concentrate that can be produced that smells like food aroma (e.g., a specific fruit, vegetable, cake with a specific flavoring such as chocolate, vanilla, strawberry, etc.) to be heated and then compressed into vapor.

In addition, the technology may employ “taptic engine,” “textured” touchscreen, or “3D touch” features enhancing the tactile experience through the user's mobile phone, tablet, consoles, etc. In the device used the taptic engine may create a strong tactile click along with a vibration to stimulate various sensations. The 3D touch feature on the device may sense pressure and assign different functions to buttons depending on how hard the user presses. Combined with haptic feedback this may create the illusion of a screen with depth. The technology may also employ the “textured” touchscreens that uses electro-vibrations and an algorithm to fool the brain into perceiving texture. In addition, the technology may utilize electromagnetic waves to allow the user to “feel” different textures on a glass surface a process known as “Electrostatic Vibration.” The technology may combine a wide range of touch sensing technologies, including capacitive, optical and resistive touch screens. In some embodiments, taptic engines can be used to create the texture of the substrate, such as a fruit or vegetable, on which the sticker is adhered.

Further embodiments may include graphics, sounds, haptic feedback and smell that mimic the natural world. The system may display graphics for each viewer's perspective. For example, a character portrayed on the ingestible sticker 10 may be created from various foods including fruit and vegetables, or may portray an animal, human, or other animate or inanimate object. The character may get its voice from hired actors who will have their voices recorded for voice over to bring the various characters to life. The characteristics of the characters may be determined by an artistic approach to the animation and entertainment to connect with kids of all ages and backgrounds.

As non-limiting examples, the voice and animation may be synchronized by any one of the following ways:
1. Pre-Animate and then record: An animator animates while knowing roughly how long a line should take to say and how the mouth enunciates things and then require the voice actor to match this as closely as possible.
2. Record, then animate manually, in other words, incorporate the voice actor's body language and facial expressions.
3. Motion Capture actor's lips while recording: get a skeletal of actor's mouth to capture the exact animation.
4. Record, then use software to parse how lips should move: use voice recognition software to tell animation program which mouth position to use.

Further embodiments may include informative graphics that may appear in the user's equipment, phone, tablet, console etc. and audio to coincide with whatever the user sees. The enhancements may be refreshed continually to reflect the movements of users' phone, tablet, console, etc.

Further, some embodiments may utilize one or more of the following features that may be included in the mobile device 10:

GPS: The ARNR application may display results based on location parameters. Location tracking tools may be used for the ARNR experience in order to determine location of the user and environment. In further embodiments, GPS may be used to determine if more than one application by more than one mobile device is directed towards the same ingestible sticker at the same location. The information can be used by the application to create virtual images that allow the two or more users of the mobile devices to interact, for example, via educational games or quizzes, discussed further below.

Compass (Magnetic Sensor): The ARNR application may also rely on direction-based data. A Compass assists ARNR display information accurately, for example, for tracking the image of the ingestible sticker in the field of view.

Orientation Sensor (Gyroscope, Accelerometer): The ARNR application may use these sensors so it may determine how you are holding the device, and which way it is moving, for example, for tracking the orientation of the ingestible sticker in the field of view.

Proximity sensor: The ARNR application may use this sensor to determine how close the phone is to a user's face, which may be used to determine how close the phone is to an element i.e. food and ingestible sticker/image. Some embodiments may also utilize the proximity sensor to change the user's 3D experience when they move their device closer to the sticker/image.

Time Sensor: The AR/VR application may use this sensor to keep track of and potentially portray the time of the AR/VR overlay.

Ambient Light sensor: The ARNR application may use this sensor to perceive the brightness in the environment in order to match the brightness of the ARNR overlay to the brightness of the environment in the field of view.

In some embodiments, a user may watch as the ingestible sticker image moves from one food to another. The ingestible sticker image may make an appearance on a second nearby food, e.g., fruit, vegetable, cake, cub-cake, cookies, etc. Ingestible stickers may be placed on adjacent food items, and the application may move the virtual image from one food item to another, causing the ingestible sticker image to seemingly appear and disappear as if it's magically moving from one fruit/vegetable to the next. In some, embodiments, the application can replicate the texture of the first food item and/or the second food item and place it over the image of the first or second ingestible sticker, respectively, so that the sticker appears to disappear from one or the other food item.

In further embodiments, users may be able to play digital games using the ingestible sticker images and characters. For example, educational quizzes and questions may be incorporated into the application that are interactive and engaging. Educational quizzes and questions may be based on content and educational curriculums. These curriculums may consist of unit descriptions, course outcomes which may include course assignments and course units that include #of Sessions/week, Objectives, etc. Furthermore, these curriculums may measure the knowledge dimension (factual, conceptual, procedural and metacognitive knowledge).

The educational game may combine the real world and virtual world as an educational platform to inspire and motivate kids to learn about the environment around them. One such feature may have the system ask various questions, regarding historical facts, information, equations etc.; and when the multiple questions are answered correctly the system may enable a video message or a game to be initiated virtually.

The educational game may further combine the real world and characters used on the ingestible stickers. The game may use the mobile device's GPS, camera, and clock to generate a fully immersive version of the real world on the mobile device.

Certain unique characters may be found in specific locations, such as Dodger stadium, Big Bear, Yosemite, Disneyland, Disneyworld, etc. If a user goes to Disneyland, for example, they're more likely to find a Disney character like Mickey mouse, Daffy Duck, Snow White, etc. who may welcome the user to the location with historical facts and information. The user may scan a sticker at a certain designated location to enable the AR/VR function.

Players may be able to win points against other players in a national database by answering questions from characters at the locations they visit. Players may earn points by answering historical facts about the various locations from these characters not just by capturing specific characters, but allowing kids to learn as well as have fun. In addition, players may be able to interact with other players within specific locations with the approval and supervision of a parent or guardian.

Other embodiments may allow for the user to record a personalized video message through their phone, tablet, etc. and save it to a local AR/VR file and then allow the user to scan an image/pic to the AR/VR file. This may result in the two files to be linked together in the system.

Hence, when a camera from the mobile device is then pointed to the image/pic, the video message may be initiated and played. For example a parent may upload a video message for their child scan an image/pic that will be placed on a cake, pastry, sticker, etc. and during the child's birthday party the image/pic on a cake can come to life when the child points his/her mobile device at the cake, pastry, sticker, etc. The video message may display the recorded voice message from the parent. This may be especially useful for our men and women in uniform who might be away and can't attend a child's birthday party when deployed in a different country.

In another embodiment, if a couple had a picture taken a few years ago, for example, on their first date, that image may be used. That picture may be converted into an ingestible sticker on a cake celebrating an event with friends and family such as a wedding anniversary. The ingestible sticker may be augmented with a 2D/3D real or animated video of the couple. When the people at the party point their mobile device cameras at the cake, they may see the augmented video on the image.

In addition, further embodiments may allow a user to record a video message and take a picture of an image, poster, banner, etc. and or written message on a wall, banner, pic, image, poster, etc. at a given location. Based on geofencing, image recognition, compass, etc., when a friend visits the same location they may hear a “knock” “knock” on the mobile device app when they open the app a picture, image, banner or whatever was used as the image for the video or written message will appear. Once they locate the picture, image, banner, wall, etc. in the real world. The user can then point the mobile device camera at the wall, banner, image, pic, poster, etc., and they may see the video and or written message left by the user who was previously at that location as long as they have the app and, in some embodiments, an encrypted password supplied by the user for security purposes.

In another embodiment, the users of AR./VR may interact with each and may go on quests to accomplish something or defeat something. As a non-limiting example, the users may embark upon a journey to defeat, create, or collect something whether it is real or virtual. Furthermore, the technology would enable the users to view the particular reality from their perspective. As such, they may defeat a “dragon” together. The users may have their own unique sticker to identify themselves in the community.

Ingestible sticker recognition may be a cloud-based Media content production of 2D/3D art, animation, and audio management system and suite of Augmented and Virtual Reality solutions for grocery retail chains and food companies. A solution designed to bring the power and persuasion of Virtual Reality and Augmented Reality. For example, shopping in a grocery retail store, live product demos, trade show or interaction with the brand or a brand's animation character(s) online. Interactive image and ingestible sticker recognition AR and VR immersive experiences may scale to enterprise, build buyer connection and identification with a brand and build brand loyalty, confidence and deliver sales wherever customers shop, online or at a physical store.

AR/VR-ready ingestible stickers may be the in-store Augmented Reality solution that provides brand or product exposure for an immersive shopping experience in retail stores. AR/VR Tradeshows, live product demos, and Industry Events may be “VR without a headset,” offering retailers and brands an intuitive and locationally flexible endless brand experience for potential customers and buyers at trade shows, live product demos, and various industry events.

The core of any brand or product visualization experience may be dynamic customized great media content. The AR/VR-ready ingestible stickers can support implementations in mobile and retail environments that require smart product content delivered efficiently.

When planning a Virtual Reality or Augmented Reality project, it's easy to focus on a specific device strategy. Using AR/VR-ready ingestible stickers, it is possible for Augmented Reality and Virtual Reality experiences so that content investment is protected and may be reused in endless applications and scenarios. Once the 2D or 3D products have been loaded into the AR/VR-ready ingestible stickers 2D or 3D content management system, they may be exported into AR/VR experiences across platforms. Different templates and support for Project Tango, Samsung GearVR, Oculus Rift, Microsoft HoloLens, HTC Vive, Google Cardboard, YouTube 360, and any other technology or head-up display that comes to market may be used.

Ingestible stickers may empower grocery retailers and food companies with realistic 2D and 3D created characters that come to life when viewed through Augmented and Virtual Reality visualization tools. The product visualization technology platform may get brands and products into the hands of prospective customers without the costs, complications and physical limitations of product samples. AR/VR-ready ingestible stickers may enable virtual 2D and 3D brand and product awareness visualization, customization and configuration to create an emotional, connected sales experience.

AR/VR-ready ingestible stickers may enable a new level of mass customization, inspiring a blend of buyer loyalty, brand awareness, product awareness, confidence, and trust. This may be accomplished through creative design work (concepts, writing, voice descriptions) and production work (voice acting, art, and animation). This may include illustration of each animation frame, animation including lip synchronization with voice, acting, and final editing and rendering.

AR/VR-ready ingestible stickers may be built for the enterprise. Applications may include content and media creations for trade shows, live product demos, events, and ecommerce. Publication options may include custom branded apps (white label) or integration into an existing mobile app (SDK).

Heavy bandwidth 2D or 3D media files may be transformed into flexible, light and dynamic content that may be created once and deployable to any device or app. With AR/VR-ready ingestible stickers, content and media files may be shared and managed independently and with multiple levels of detail for both repurposing and future-editing. AR/VR-ready ingestible stickers may enable efficient, scalable upload and distribution of 2D and 3D media files that are cross-platform compatible, supporting Google Tango, iOS, Android and HMD/Samsung GearVR and all emerging HUD and AR technologies.

App design may include User Interface element design, Game Design, storyboards, and mockups. App programming may include custom interactions, forms, social media integration, and cloud service integration. Content Management and Optimization may include Content Guidelines with 2D/3D file format specifications, texture file sizes, and/or audio/video codecs.

Although exemplary embodiments of the present invention have been described, it is understood that the present invention should not be limited to these exemplary embodiments but various changes and modifications can be made by one ordinary skilled in the art within the spirit and scope of the present invention as hereinafter claimed by appended claims and equivalents thereof.

What is claimed is:

1. An ingestible sticker comprising:
an edible paper and
an edible ink on a surface of the edible paper creating a sticker image, wherein the sticker image is configured to be recognized by an augmented or virtual reality capable device.

2. The ingestible sticker of claim 1, wherein the edible paper comprises of a food grade material that has adhesive qualities when combined with moisture.

3. The ingestible sticker of claim 1, wherein the edible ink comprises natural dye pigments.

4. A system for creating an augmented or virtual reality experience using an ingestible sticker, comprising:
the ingestible sticker comprising:
an edible paper and
an edible ink on a surface of the edible paper creating a sticker image, wherein the sticker image is configured to be recognized by an augmented or virtual reality capable device; and
an application stored in a memory of the augmented or virtual reality capable device and configured to create an augmented or virtual reality when the application is running and the ingestible sticker is located.

5. The system of claim 4, wherein the application comprises a set of instructions that, when executed by a processor of the augmented or virtual reality capable device, causes the processor to recognize the sticker image.

6. The system of claim 5, wherein the application comprises a set of instructions that, when executed by a processor of the augmented or virtual reality capable device, causes the processor to overlay a virtual image on the sticker image.

7. The system of claim 5, wherein the application comprises a set of instructions that, when executed by a processor of the augmented or virtual reality capable device, causes the processor to display the virtual image over the sticker image on a screen of the augmented or virtual reality capable device.

8. The system of claim 5, wherein the application comprises a set of instructions that, when executed by a processor of the augmented or virtual reality capable device, causes the processor to track a position and an orientation of the sticker image within a field of view of a camera of the augmented or virtual reality capable device.

9. The system of claim 8, wherein the application comprises a set of instructions that, when executed by a processor of the augmented or virtual reality capable device, causes the processor to update the position and the orientation of the ingestible sticker based on tracking information.

10. The system of claim 6, wherein the virtual image is the same shape and size as the sticker image.

11. A method for using an ingestible sticker with an augmented or virtual reality application, the ingestible sticker comprising an edible paper and an edible ink on a surface of the edible paper creating a sticker image, wherein the sticker image is configured to be recognized by an augmented or virtual reality capable device and wherein the application is configured to be stored in a memory of the augmented or virtual reality capable device, the mobile device having a screen and a camera, the method comprising:
affixing the ingestible sticker to a designated substrate;
loading the application on the augmented or virtual reality capable device;
directing the camera of the augmented or virtual reality capable device at the ingestible sticker;
retrieving sensory information from the camera by the application;
recognizing the sticker image of the ingestible sticker; and
initiating a augmented or virtual reality experience based on the recognized sticker image.

12. The method of claim 11, further comprising displaying a virtual image over the recognized sticker image on the screen of the augmented or virtual reality capable device.

13. The method of claim 11, further comprising tracking a position and an orientation of the recognized sticker image within a field of view of the camera.

14. The method of claim 13, further comprising updating the position and the orientation of the recognized sticker image based on tracking information.
